(19) United States
(12) Patent Application Publication
(10) Pub. No.: US 2013/0297674 A1
(43) Pub. Date: Nov. 7, 2013

(54) TECHNIQUES FOR DEVELOPING LOCALIZED MARKETS THROUGH BUSINESS TRANSACTIONS OVER A DATA COMMUNICATION NETWORK

(71) Applicant: Arvind Jain, Redwood City, CA (US)

(72) Inventor: Arvind Jain, Redwood City, CA (US)

(73) Assignee: DEALPalette, Inc, Redwood City, CA (US)

(21) Appl. No.: 13/466,108

(22) Filed: May 7, 2012

(51) Int. Cl. G06F 15/16

(52) U.S. Cl. 709/203

(57) ABSTRACT

Methods and systems for developing localized markets using business transactions conducted over a data network having a plurality of servers features creating a data connection with one of the plurality of servers from a client terminal. A search query is transmitted to the one of the plurality of servers. The search query requests product information to be transmitted between the server and the client identifying products satisfying a criterion of the search query. Determined is whether the one of the plurality of servers includes the information. An identity of a second server from the remaining servers of the plurality of servers that includes the product information by examining a UDDI repository table located on the one of the plurality of servers, in response to determining the product information is absent from the one of the plurality of servers. A message is sent to the client terminal with results from the product information.

### FIELD OF THE INVENTION

The current invention relates generally to the sales of products advertised over a network. More particularly the current invention relates to conducting transactions between business and consumers over a data communication network.

### BACKGROUND

Social networking, online content providers, multimedia services, match-making, coupon sites, deals portals, and ecommerce sites are expanding exponentially. Business-to-business marketing programs and similarly business-to-consumer marketing programs are typically conducted using disparate point solutions such as websites, inventory system, catalog management, shopping carts, coupon generators, payment processors, sales/CRM management, social marketing platforms, and online service providers. This has proven, for some, to be an inefficient e-commerce model for marketing and delivering products, e.g., goods and services. Specifically, many businesses have determined that consumers are generally attracted to e-commerce sites that cater to local interests. These consumers are often more comfortable entering into transactions with business located proximate to the consumer, i.e., a local business. Thus, businesses transacting with large e-commerce vendors, e.g., Amazon, eBay and the like, find problematic directing transactions to local markets. The large e-commerce vendors have e-commerce models directed to marketing outside of localized markets, e.g., global markets. As such the development of local markets is problematic. Moreover business that are recently migrating to e-commerce transactions are often employing legacy IT infrastructure, which is cumbersome and often ill-suited for modern e-commerce solutions.

A need exists, therefore, to provide efficient techniques to allow businesses to develop e-commerce business models that facilitate the development of localized markets.

### BRIEF SUMMARY

Techniques for developing localized markets using business transactions conducted over a data network having a plurality of servers that features creating a data connection with one of the plurality of servers from a client terminal; transmitting a search query to the one of the plurality of servers requesting product information to be transmitted between the server and the client identifying products satisfying a criteria of the search query; determining whether the one of the plurality of servers includes the information; ascertaining an identity of a second server from the remaining servers of the plurality of servers that includes the product information by examining a UDDI repository table located on the one of the plurality of servers, in response to determining the product information is absent from the one of the plurality of servers; and sending a message to the client terminal with results from the product information. These and other embodiments are described more fully below.

### BRIEF DESCRIPTION OF THE DRAWINGS

In the following drawings like reference numbers are used to refer to like elements. Although the following figures depict various examples of the invention, the invention is not limited to the examples depicted in the figures.

FIG. 1 is a plan view showing the architecture in which the current invention is implemented.

FIG. 2 is a plan view showing consumer webpage through which a consumer can access the invention on the architecture shown in FIG. 1.

FIG. 3 is a plan view showing consumer webpage to facilitate transaction with a vendor for products using the architecture shown in FIG. 1.

FIG. 4 is a consumer webpage upon which a favorites list of products is shown.

FIG. 5 is vendor webpage through which a vendor gains access to the invention on the architecture shown in FIG. 1.

FIG. 6 is a plan view shown of a distributed architecture of server side facilities, shown in FIG. 1 in accordance with an alternate embodiment of the present invention.

### DETAILED DESCRIPTION

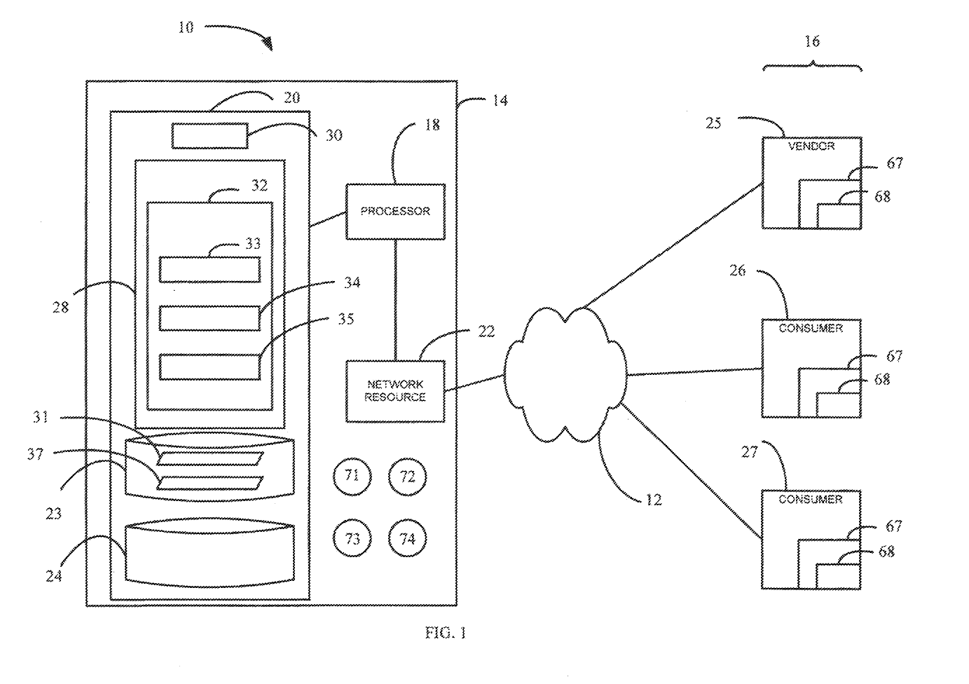

Referring to FIG. 1, shown is computer architecture 10 for conducting e-commerce transactions over a network 12 that develops localized markets is shown including server side facilities 14 and user side facilities 16. Server side facilities 14 and user side facilities 16 are may be placed in continuous and/or selected data communication over network 12. Network 12 can be any one or any combination of a LAN (local area network), WAN (wide area network), telephone network, mobile network, point-to-point network, star network, token ring network, hub network, or other appropriate configuration. As the most common type of computer network in current use is a TCP/IP (Transfer Control Protocol and Internet Protocol) network, referred to as the Internet. However, it should be understood that the networks that the present invention might use are not so limited, although TCP/IP is a frequently implemented protocol. Server side facilities 14 includes processor sub-system 18, memory space 20, in data communication therewith, and network resources 22 in data communication with both memory space 20 and processor sub-system 18. Processor sub-system 18 may be any known processor sub-system in the art, the CORE DUO® or the CORE 2 DUO® from Intel Corporation of Santa Clara, Calif. Memory space 20 includes drive storage 21, shown as one or more hard drives 23 and 24, as well as data and instruction registers, shown as 28, and volatile and non-volatile memory shown as 30. Data communication network 12 may be any network or combination of networks of devices that communicate with one another.

To facilitate development of e-commerce server side facilities includes a social netmarketing environment 32 (SNE) that is a software application platform used for building and deploying communication solutions over network 12 to facilitate e-commerce transactions. SNE 32 supports all computer platforms running with Linux or WINDOWS operating system hardware platforms, communication and networking protocols. The SNE 32 serves many functions, including providing both single and multi-tenant applications for use by businesses, consumers, and others over network 12. SNE 32 facilitates, maintaining common information schemas and repositories in language neutral XML protocols, which may be independent of databases, sharing and coordinating information between businesses and/or consumers and a development environment for rapidly building and deploying new software as a service (SaaS). SNE 32 manages the various systems and resources for scalability, high availability, performance, and security over the network. SNE 32 provides the framework for delivering developed solutions on a SaaS appliance for private enterprise use or for public infrastructure. SNE 32 maintains logs and electronic traces for compliance review and audits, provides plug-ins for integration with third party offerings, and tools and support for handshake with open-source solutions and standards initiatives. With SNE 32, information technology organizations can build new social netMarketplaces and social networking solutions for business and/or integrate with other SaaS infrastructure and networks globally. SNE 32 offers an extensible platform for packaging or embedding other third-party standards based solution offerings as Application Service Provider (ASP) services on the Internet. SNE 32 can also be customized to country specific regulations and compliance requirements. SNE 32 can be delivered on a variety of hardware platforms and networking infrastructure, serving enterprises of all sizes.

SNE 32 has three layers, shown as run-time object layer 33 (RTL); application layer 34 (APL); and services infrastructure layer 35 (SIL). RTL 33 is an object container for applications and services. APL 34 consists of software application frameworks, development tools used to build dynamic user interfaces; including system and resource management services. SIL 35 integrates both internal and external applications over network 12.

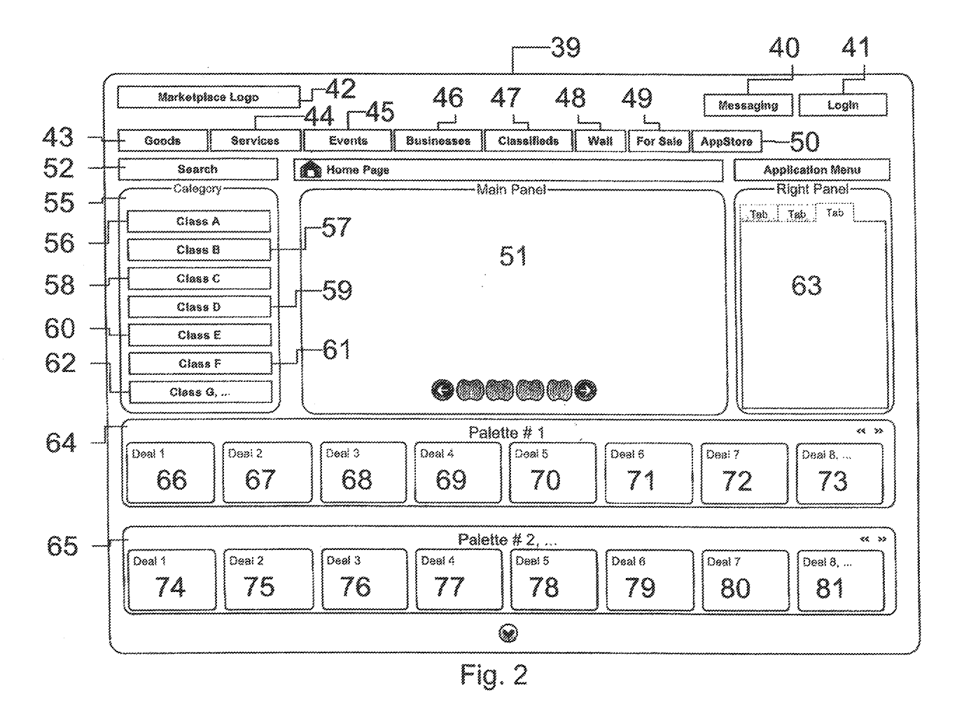

Server side facilities 14 allows access to a SNE 32 by one or more users 25-27 of user side facilities 16 over data communication network 12. Users 25-27 are generally one of two groups of users, vendors, shown generally as 25, and consumers, shown as 26 and 27. Architecture 10 enables users 25-27 to conduct transactions that facilitate development of localized markets over a computer network. To that end, each user 25-27 has associated therewith a general processing computer, i.e., client terminal 67 with an SNE 32 client 68 running thereon to access to SNE. Known security protocols are applied to ensure that information contained on architecture 10 may be accessed only by users 25-27 having proper credentials. Typically vendors obtain rights from the owner (not shown) of architecture 10 to store information, referred to as vendor information 31, on server side facilities 14. Vendor information 31 is that which facilitates promotions of products, e.g., services and/or goods, and also includes profile information of the vendor 25 for accounting purposes and to verify access levels to architecture. For example, a vendor 25 may be a wholesaler of goods and/or services or a retailer that sales goods and/or services or both. Using architecture 10 a provider may allow consumers to enter into transactions with vendors. To gain access to SNE 32 one or more of consumer users 26 and 27 goes to an appropriate uniform resource locator (url) using a standard browser application, such as FIREFOX, INTERNET EXPLORER and the like. In response a user application webpage (UAW) 39 is displayed, shown in FIG. 2. Like vendors 25, consumers 26 and 27 have stored on server side facilities 14 profile information 37. Profile information 37 includes information about consumers 26 and 27 used to authenticate the consumer for access to architecture 10, as well as other information concerning consumer's 26 and 27 use of architecture 10, e.g., last product viewed, the last location from which consumer 26 and 27 access SNE 32, a home location for consumer 26 and 27 and the like. In this manner, client terminal 67 creates a data connection with server side facilities 14.

Referring to both FIGS. 1 and 2, UAW 39 is generated by APL 34 of SNE 32 and includes a plurality of fields that one or more of consumers 26 and 27 may employ to search for desired content. In the present example UAW 39 allows a consumer of one or more consumers 26 and 27 to search for products, e.g., goods or services. In this manner UAW 39 facilitates transactions with providers on architecture 10 deals in order to develop a market place and/or brand recognition. UAW 39 also takes advantage of the networking functionality of architecture 10 and provides social networking capabilities to consumers 26 and 27 thereof. For example, UAW 39 allows scheduling functionality, e.g., social and business calendaring, requesting quotes for products from one or more vendors 25 by allowing direct communication therewith. To that end, UAW 39 includes a messaging virtual button 40 (MVB). Activation of MVB 40 launches an instant messaging service (not shown) that is well known in the art to allow users 25-27 of architecture to communicate over network 12. Also included in UAW 39 is a log-in virtual button 41 (LVB). Activation of LVB 41 launch log-in window (not shown) into which consumer 26 or 27 may enter information to verify access levels that user 26 or 27 has to information on architecture 10. To that end, information entered into log-in window (not shown) is compared with information in vendor information 37 to determine whether consumer 26 or 27 has access to architecture 10, using well known security protocols.

Upon logging in, UAW 39 displays in a marketplace logo region 42 (MLR) information identifying the industry and/or market segment that consumer 26 or 27 is currently viewing, which may be virtually any market segment. Examples of market segments include automotive, healthcare, entertainment, music, government and the like. UAW includes multiple modules, one of which is accessed by goods virtual button (GVB) 43. Activation of GVB 43 renders a box (not shown) that provides a list of products from various vendors associated with the particular market, i.e., the industry indicated in MLR 42. It is desired that the products listed in response to activation of GVB 43 for a given industry be mutually exclusive of the products listed for other industries. However, it is no unforeseeable that overlap exists, such that the same product may be associated with two different industries. The services virtual button (SVB) 44 renders a box (not show) showing a list of services provided by vendors associated with the industry associated with MLR 42. An events virtual button (EVB) 45 is also provided on UAW 39. Activation of EVB 45 renders a box (not shown) that lists events promoted by the various vendors operating on architecture. For example, a particular vendor may have a reduced price for certain products provided and/or coupons or other promotional information. Business virtual button (BVB) 46 renders a box providing a list of vendors associated with the industry identified in MLR 42 that are proximate to the user of UAW 39. This is achieved by SNE 32 comparing the vendor information 31 with profile information 36 to determine whether a predetermined criterion is satisfied, discussed more fully below.

Typically, when a consumer 26 and 27 logs-in to UAW 39 vendor information 31 is checked against profile information 37 of consumer 26 and 27. Content related to vendors rendered by activation of BBV 46 would be based upon a criteria selected by the consumer 26 and 27 and/or owner of architecture 10, e.g., a range of distance from the user registered location, as set forth in the user profile, a zip code associated with the user and the like. A Classified Virtual Button (CVB) 47 is provided to facilitate social and business networking using UAW 39 with other consumers and/or vendors architecture 10. An example of information that may be provided and/or retrieved using CVB 47 includes job postings resume and the like. Application Store Virtual Button 50 (ASB) provides access to software applications that facilitate a specific transaction. Specifically, activation of ASB 50 renders a box (not shown) that has a list of software applications. For example, in the case of the automotive industry software applications would be listed that are relevant to the automotive industry, such as software application for diagnostics equipment, tools and the like. These applications render content in main panel 51 that typically includes images and/or video as well as textual descriptions of the products, such as price, features warranties and the like. A Search Entry Field 52 (SEF) provides the ability to enter a search query therein and search for a deal and provide capabilities to compare similar deals from various vendors 25 using architecture 10. After entering a search query into SEF 52 a consumer 26 or 27 would depress a return key on keyboard (not shown) in data communication with client terminal 67. The results (not shown) of the query would be transmitted as a message from server side facilities 14 and rendered in main panel 51. Typically, the search term will be in furtherance of acquiring a list of products availability from the industry identified by MLR 42. Content associated with the results of the search are shown in main panel 51. The content may include images and/or video, as well as textual information describing the produce and/or deals and coupons or other discounts. The search results may be in the form of text and hyptertext links (not shown) that lead to the webpage of the vendor that is outside of architecture, e.g., a webpage in the Internet from which the products or other services to facilitate the transaction are available, e.g., third party warranties that may be purchased, financial institutions that may provide loans to acquire the product, credit reporting services and the like.

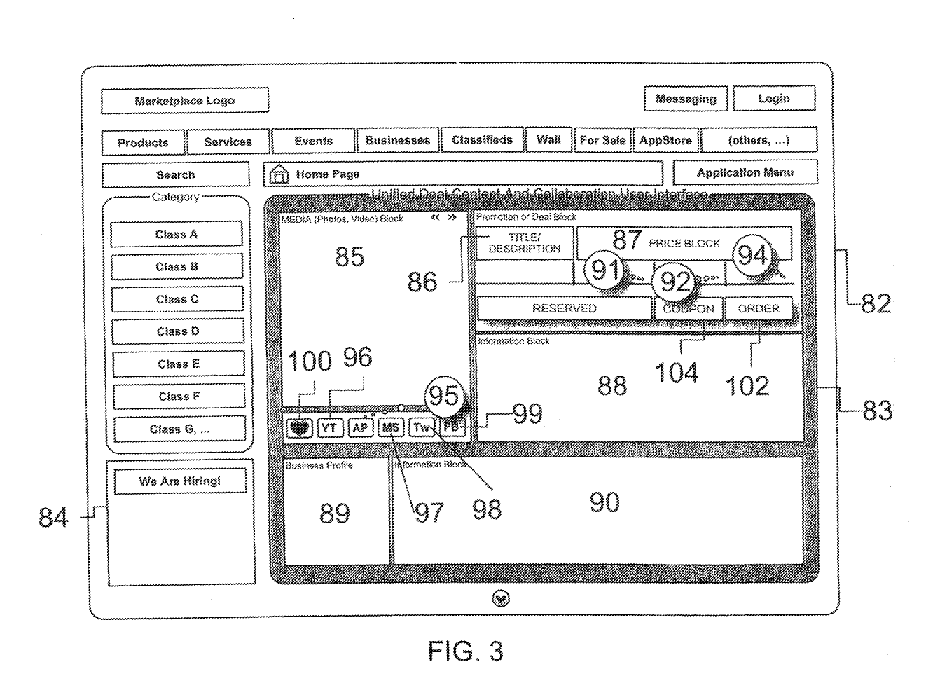

A Category panel 55 displays product classifications available for the industry identified in MLR 42. Seven different products, goods or services, are shown as 56-62. For example, were UAW 39 directed toward the automotive industry, class 56 may be directed to the service of Oil Change and class 57 could be directed to the service of Brakes & Wheel Alignment, just to name a few. Also included on UAW 39 may be a general information region (GIR) 63 in which where information such as News, Top Deals, Blogs, RSS feed may be displayed. Application Palettes 64 and 65 may be used to draw attention to promoted deals by vendors associated with the industry identified in MLR 42. Each palette 64 and 65 include one or more deal regions, shown as 66-73 for palette 61 and 74-81 for palette 65. Each region 66-81 is a virtual button that opens an additional webpage 82, shown in FIG. 3.

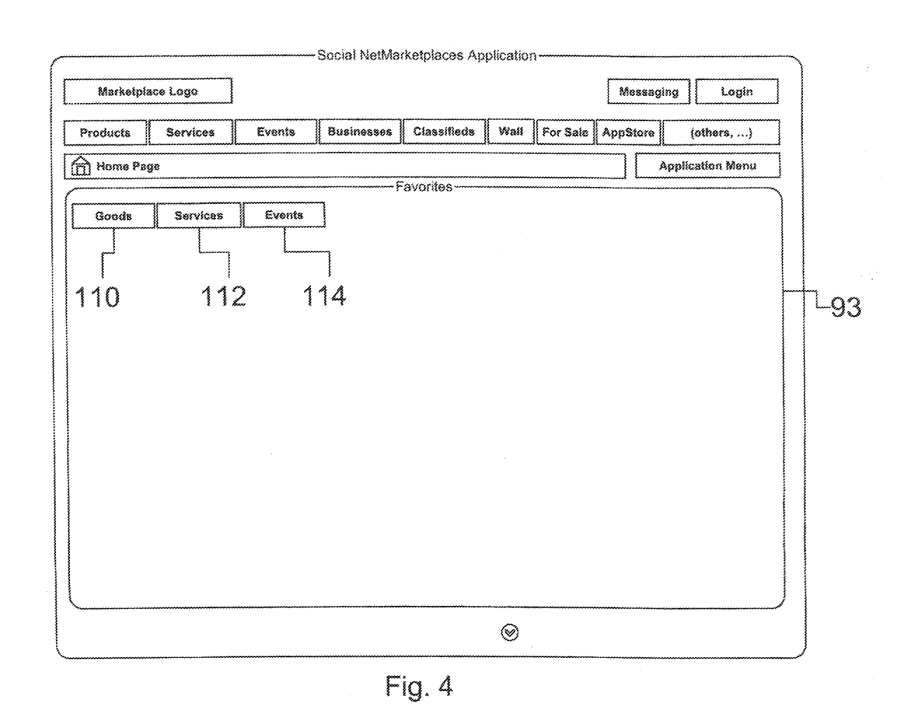

Referring to FIG. 3, web page 82 is substantially identical to UAW 39; however, main panel 51 CUR 63 and palettes 64 and 65 have been replaced with a Deal Content and Collaboration User Interface (DUI) 83 and a recruiting information region (RIR) 84. DUI 83 includes multiple regions, including an imaging region 85, a title region 86, a pricing region 87, a detailed information regions 88, 89 and 90, preferences region 91, a my favorites region 92, a my page region 94 and a my profile region 95. Imaging region 85 may include a picture or a video of the product that is the subject of the transaction and title region 86 includes the name of the product. Pricing region 87 includes information concerning the price of the product. Detailed information regions 88-90 may include additional information concerning the product and/or the vendor that is providing the product. Preferences region 91 allows a user to modify personal information, e.g., change passwords, and manage subscriptions to various industries of products. My Favorites region 92 is a virtual button that renders My Favorites web page (VIEW) 93, shown in FIG. 4. MFW 93 displays all products added by the user to the user's favorite list. It may also be used to manage demand based price discounts that are applied, discussed more fully below.

Referring again to FIG. 3, my page region 94 renders another web page (not shown) that displays appointments, messages, rewards posted by various vendors, and other applications that the consumer can use such as request for a quote, and in the case of a vertical market segment, additional features such as to register automobiles, post items for sale onto the marketplace and the like. My profile region 94 renders another web page (not shown) that allows consumers 26 and 27 to create professional profiles that can be used to respond to various jobs posted online by the vendors. Various social networking websites may be contact through DUI 83 by activating one of many virtual buttons 96, 97, 98 and 99. For example virtual button 96 connects to You Tube; virtual button 97 connects to online Messaging Service; virtual button 98 connects to TWITTER and virtual button 99 connects to FACEBOOK. Virtual button 100 having the heart symbol may be used to enter data concerning the product identified in title region 86 to favorite list MFW 93 shown in FIG. 4. To order the product identified in region 86 an order virtual button 102 may be activated which connects to any one or more of well known exchange portals (not shown), e.g., PAYPAY and the like. Were any discounts or other purchase incentives available a coupon virtual button 104 may be activated to take advantage of the same.

Referring to both FIGS. 1 and 4, MFW 93 would contain a list of products, services or events that have been identified as being favorites of the user. When a consumer 26 or 27 selects goods or services from list dynamic pricing may be invoked that calculates a price, shown in pricing region 87, using real-time demand data; this is then displayed to the user in FIG. 3. Were a vendor 25 to opt to provide dynamic pricing for products, information in favorite list for each consumer 26 and 27 for a given product is tallied and the price may be adjusted based upon the demand so as to be either proportional or indirectly proportional with the demand. For example, assume a product is limited in supply, an upwardly trend in demand may produce an upwardly adjustment in price, e.g., the cost of the product to consumer 26 or 27 increases. Alternatively, it is entirely possible that vendor 25 would have access to products that are subject to downwardly price adjustments based upon volume discounts. For example, assume that the product included a combination of goods and services such as in the case of an oil change for a vehicle. It may very well be that with a sufficient quantity of oil filters and oil purchased by vendor 25 provided is a 10% discount of the oil filters and oil. This savings by the vendor may be passed-along to consumer 26 or 26 that identified the product as a favorite. In this mariner, it would behoove consumer to check back and determine the price for the product identified in pricing region 87. Alternatively, or in conjunction therewith, a n instant message may be transmitted to consumer 26 or 27 once a price change has occurred for a product recited in MFW 93. It is entirely conceivable that MEW 93 include a data entry field (not shown) whereby a communication is transmitted to a consumer 26 or 27 once a product identified in MFW 93 has op/ice associated therewith that is below a predetermined threshold. The communication may be by way of an instant message transmitted through architecture 10 and/or e-mail, or cellular telephone and the like. To provide dynamic pricing application APL 34 includes an dynamic pricing application that establishes price based upon the following:

$${LimitP}_{( x -> d )} ( x ) = S {P}_{( e )} - {\vert {[ {LimitD}_{( x -> d )} ( X ) ]}_{( f , p )} \vert}_{( b , t )}$$

where SP(e)=Selling price; D(x)=applicable discount where the discount could be a fixed price or percentage; P(x)=price for a given demand level where demand could be hulk or tiered quantity based; e=list price or estimated; f=fixed discount; p=percent discount; b bulk quantity pricing; t=tiered quantity pricing; and d=dynamic demand or the total interest at any given time period.

Typically only one category is recited on MFW 93 at a given time. To that end, three filter virtual buttons are provided 110, 112 and 114. Activation of button 110 would filter any information related to services or events from being rendered on MFW 93, i.e., only information associated with goods would be recited. Activating virtual button 112 would filter any information related to goods or events from being rendered on MFW 93, i.e., only information associated with services would be recited. Activating virtual button 114 would filter any information related to goods or services from being rendered on MEW 933, only information associated with events would be recited.

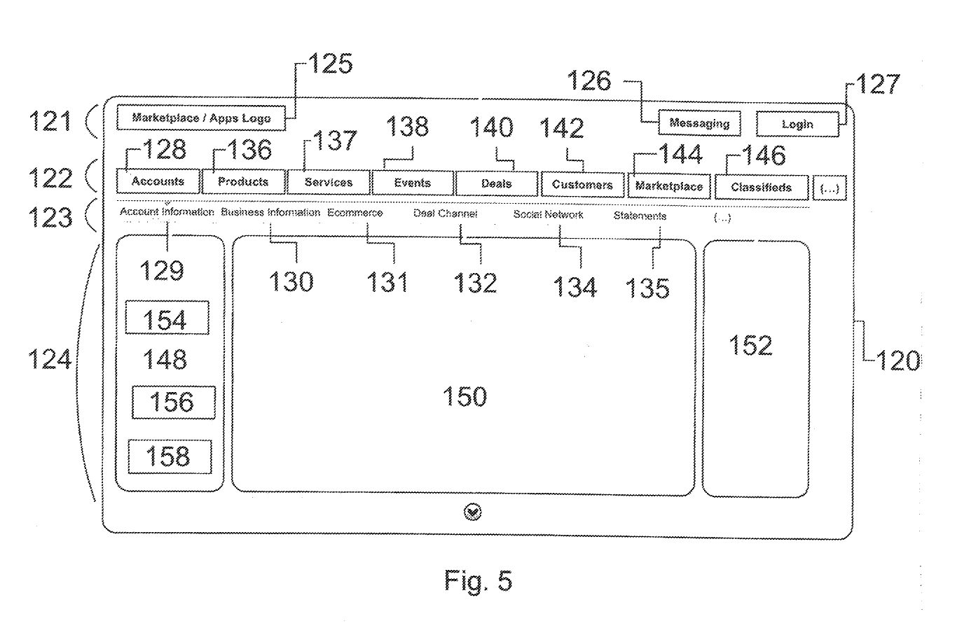

Referring to FIGS. 1 and 5 to vendors 25 gain access to SNE 32 by going to an appropriate uniform resource locator (url) using a standard browser application, as discussed above with respect to consumers. In response a user application webpage (BUW) 120 is displayed. BUW 120 is generated by APL 34 of SNE 32 and includes a plurality of fields that one or more of vendors 25 employs to promote products, e.g., goods and/or services, using architecture 10. To that end, BUW 120 includes multiple regions, shown as 121, 122, 123 and 124 used to enter information into SNE 32 to promote products.

Region 121 includes a plurality of virtual buttons 125, 126 and 127, which perform the same functionality as buttons 42, 40 and 41, respectively shown in FIG. 2. Referring again to FIGS. 1 and 5, region 122 includes a plurality of virtual buttons, each of which allows access to a different application SNE 32. Virtual button 128 allows access to the Accounts application, which generates virtual buttons 129-135 in region 123. Accounts Information button 129 renders an accounts screen (not shown) that provides vendor 25 access to modify login and passwords. Business information button 130 allows vendors 25 to access to modify business Information so as to target certain industries and/or markets and identify hours of operation, business history, tax information, billing, shipping, appointments and the like. E-commerce button 131 allows vendors 25 to create and/or modify accounts with various existing e-commerce business, such as Google Cart and payment processors. Virtual button 132 allows vendors 25 to create and/or modify create private groups within architecture 10 to promote products. Virtual button 134 allows vendors 25 to manage social network accounts, such as FACEBOOK, TWITTER, GOOGLE and the like. Virtual button 135 allows vendors 25 create and/or modify transaction statements, such as month-end transaction statements, analysis and the like. Other applications accessed through region 122 provide functionality for generated a catalog, pricing, deal creation, and publication of information concerning products employing virtual button 136. Virtual button 137 allows vendors 25 to provide or generate a catalog, pricing, deal creation, and publication of information concerning services. Virtual button 138 allows vendors 25 to create and/or modify event information on SNE 32 that may be perceived by users 25-27. Events may be deals, sales, incentive giveaways and the like. To that end button 138 allows vendors 25 to provide information related to one or more events, such as pricing, schedules, deal creation and publication. Virtual button 140 allows vendors 25 to access create and/or modify deal on SNE 32 and may include information related to managing a lifecycle of deal. Virtual button 142 allows vendors 25 to create and/or modify customer information on SNE 32 that is associated with a consumer. Information that may be associated therewith includes customer information, market segmentation, deal analysis. Virtual button 144 allows vendors 25 to create and/or modify information related to a marketplace for testing various deal scenarios before posting for access on architecture 10 for customer users 25-27. Virtual button 146 allows vendors 25 to create and/or modify information related to a classifieds, e.g., job postings for the vendor associated with BUW 120.

Multiple data panels of information are included in region 124 of BUW 120. The number and size and arrangement of panels in region 124 are dependent upon the application activated by virtual buttons 128, 136-146. Three information panels 148, 150 and 152 are shown. The content in each information pane 148, 150 and 152 is dependent upon the application activate. Typically, however, each information panel 148, 150 and 152 will include one or more data entry boxes, shown generally as 154 and pull down menus, shown generally as 156 and image regions, shown generally a 158. A vendor creates and/or modifies information on SNE 32 by changing data associated with or more of data entry boxes 154, pull down menus, 156 and/or image regions 158.

After information is entered through BUW 120 by vendor 25, a consumer 26 and 27 may access the same using UAW 39. For example, a consumer 26 and 27 would access (DUI) 83 through UAW 39 by activating one of virtual buttons 56-62 or one of virtual buttons 66-81. Were a consumer 26 and 27 desirous of acquiring a product associated with one of the aforementioned virtual buttons, a consumer 26 and 27 would merely activate virtual button 102 to purchase the same.

Referring again to FIGS. 1 and 2, one of the benefits of architecture 10 is the ability of consumers 26 and 27 to search for various products with different search criteria. For example, it is known that consumers desire to transact business with vendors that are located proximate to the consumer. To that end, a consumer 26 and 27 may employ SEF 52 to search for information associated with a product. Typically, the location of the consumer 26 and 27 includes information concerning the location of the consumer 26 and 27 as mentioned above. Thus, employing SEF 52, SNE 32 will restrict information concerning products that were the subject of a search to not only the products desired, but also to a region proximate to the consumer that initiated the search. Such a geographic restriction may be based upon several criteria such that information for vendors in response to a search query will be provided only if the vendor has a common zip code with the consumer; or is with a desired range of distance; or the vendor and the consumer are associated with a common political organization, such as a city county and/or state. In this manner, architecture 10 facilitates the development of localized markets for products and, as a such, facilitate recognition of a vendor's brand in the market.

Referring again to FIG. 1, although only a single server side facilities 14 is shown, it is desirous that multiple server side facilities would be employed, shown as 14, 314, 414, 514 in data communication with network 12. Each of server side facilities is substantially the same as server side facilities 14, but may be configured to run different operating systems. A plurality of user terminals is also in data communication with network 226, each of which is a general processing computer system. Typically, a consumer executing a search for a product is limited to recovering relevant information from server side facilities 14 to which consumer 26 or 27 is logged-in. However, information relevant to the search may be present on other server side facilities 14, 314, 414, 514. It is desirous that a consumer running a search for products be allowed to access information contained on server side facilities to which the consumer is not logged-in. To that end, SIL 35 includes programs API's and applications to build virtual data interfaces for information exchange over network 12. In one embodiment, leveraging web services industry standard the interfaces created are registered in a standards based UDDI repository table 166, 366, 466, 566 located in each of server side facilities 14, 314, 414, 514, respectively. UDDI repository serves a directory for expeditious look-ups and access to data contained on systems other than the system upon which it resides. For example, UDDI repository table 166 may point to server side facilities 314, 414 and 514; UDDI repository table 366 may point to server side facilities 14, 414 and 514; UDDI repository table 466 may point to server side facilities 14, 314 and 514; and UDDI repository table 566 may point to server side facilities 14, 314 and 414.

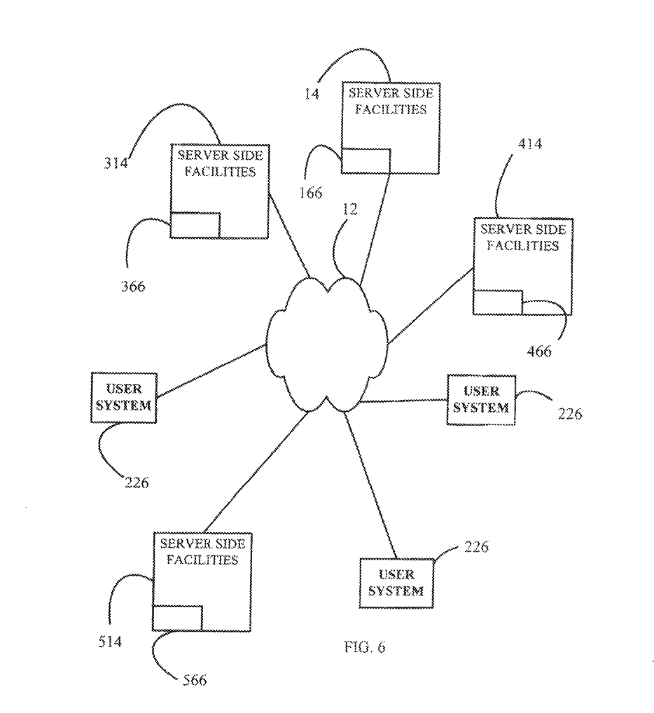

In operation, when a consumer executes a search employing SEF 52, SIL 35 leverages standards based J2EE and web Services technology stack, tools and resources of third parties or open source standards to build and deploy methods including web services interfaces (virtual interfaces) for various type of data sources such as relational databases and non-relational systems as shown as nodes or webservice endpoints 171-174 in FIG. 1 on server side facilities 14 and 371-374 on server side facilities 314, 471-474 on server side facilities 414; and 571-574 on server side facilities 514, shown in FIG. 6. These methods could be simple or composite depending upon the number of data sources and applications that are to be integrated. By, way of example, the interfaces, also known as Webservices and its associated Web Service Descriptive Language (WSDL) documents are registered in one or more of UDDI depositories 166, 366, 466 and 566. For example, webservice endpoints 171, 371, 471 and 571 could each be a zip code based search, e.g., information retrieved would be based upon a matching zip code that is associated with the retrieved information to the zip code that is the subject of the web service method 171, 371, 471 and 571. Similarly, webservices 172, 372, 472 and 572 could each be a political geographic area search, such as a particularly city, e.g., Los Angeles, New York, Bombay and the like. Webservices 173, 373, 473 and 573 may be a product name and/or type search. Virtually any type of criterion may be the subject of the webservices, which is shown as 174, 374, 474 and 574. The WSDL, documents are then accessible by SNE 32 through either UAW 39 or ROW 82. In this manner, a consumer 26 and 27 logged-in to one of serve side facilities 14, 314, 414 or 514 may retrieve data from any of the remaining server side facilities 14, 314, 414 and 514 without having to be logged-in to the remaining server side facilities 14, 314, 414 and 514. Thus a consumer may locate products from all server side facilities in data communication with network 12, assuming the search criteria are satisfied, e.g., proximity requirements between vendors 25 and consumers 26 and 27. For example, assume sides facilities 14 is located in California and server side facilities 314 is located in New York and one of users systems 226 is logged-in to server side facilities 14. Upon searching for a product on architecture, SNE 32 would first search of relevant information on server side facilities 14 using any local geographic preference previously established by consumer 26 and 27. Were the location provided by consumer 26 and 27 outside of the previously established local geographic preference SIL 35 calls a web services for the given zip code New York were it determined from UDDI repository table 166 that relevant information would be located on server side facilities 314. The results are then passed back to consumer 26 and 27 logged-in to server side facilities 14, i.e., a message is transmitted to client terminal 67 with the result of the search.

Sit, 35 may also include programs and API's to interact with text files, XML objects, speech objects, relational and non-relational databases, JSON objects, EDI files, DICOM imaging, binary files, HL7, Java Mail APIs, RSS feeds, JMS based messaging systems, over TCP/IP based network as well as Internet protocols such as http. By way of example, services API's facilitates interactions with various third party applications such as Oracle Advance Queuing System, IBM MQ Series, Electronic Health Record (FIR) systems using HL7, Insurance or payor systems supporting EDI/X12 standards, and such. SIL 35 also includes API's for information exchange with social networks such as Facebook, Twitter, You Tube, Google+, just to name a few. Services API's and modules can be embedded in the applications or they can be accessed by other systems directly via calls made to the respective services API's.

White the invention has been described by way of example and in terms of the specific embodiments, it is to be understood that the invention is not limited to the disclosed embodiments. To the contrary, it is intended to cover various modifications and similar arrangements as would be apparent to those skilled in the art. For example, the present processes may be embodied as a computer program product that includes a machine-readable storage medium (media) having instructions stored thereon/in which can be used to program a computer to perform any of the processes of the embodiments described herein.

Computer code for operating and configuring the server system to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP), HTTPS, Ethernet, etc.) as are well known. It will also be appreciated that computer code for implementing embodiments of the present invention can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.). Therefore, the scope of the appended claims should be accorded the broadest interpretation so as to encompass all such modifications and similar arrangements.

1. A method for developing localized markets using business transactions conducted over a data network having a plurality of servers, said method comprising:
creating a data connection between one of said plurality of servers and a client terminal;
transmitting a search query between said one of said plurality of servers and said client requesting product information to be transmitted between said one of said plurality of servers and said client identifying products satisfying a criteria of said search query;
determining whether said one of said plurality of servers includes said information;
ascertaining an identity of a second server from the remaining servers of said plurality of servers that includes said product information by examining a UDDI repository table located on said one of said plurality of servers, in response to determining said product information is absent from said one of said plurality of servers; and
sending a message to said client terminal with results from said product information.

2. The method as recited in claim 1 wherein transmitting further includes transmitting said search query with said criteria that includes a specified geographic region in which products corresponding to said product information may be purchased.

3. The method as recited in claim 1 wherein transmitting further includes transmitting said search query with said criteria that includes a maximum distance from said client terminal that products corresponding to said product information may be purchased.

4. The method as recited in claim 1 wherein sending further includes sending said message containing results indicating that no products match said search criteria.

5. The method as recited in claim 1 wherein sending further includes following ascertaining and before sending examining a UDDI repository table of said second server to identify an additional server from the plurality of servers, excluding said first and second servers, that includes said product information.

6. The method as recited in claim 1 further including an providing additional client terminal and a vendor application and a consumer application both residing on said server, with said additional client terminal having access to said vendor application, defining a vendor client terminal and said client terminal having access to said consumer application, communicating between said client terminal and said vendor terminal through said server employing an instant messaging network.

7. The method as recited in claim 1 further including an providing additional client terminal and a vendor information and a consumer application both residing on said server, with said additional client terminal having access to modify said vendor information, defining a vendor client terminal and said client terminal having access to said consumer application, with said vendor information including data concerning available opportunities and said consumer application rendering said employment opportunities in response to products associated with said vendor information.

8. A method for developing localized markets using business transactions conducted over a data network having a plurality of servers, said method comprising:
creating a data connection between one of said plurality of servers and a client terminal;
transmitting a search query between said one of said plurality of servers and said client requesting product information to be transmitted between said one of said plurality of servers and said client identifying products satisfying a criteria of said search query, with said criteria that includes a specified geographic region in which products corresponding to said product information may be purchased;
determining whether said one of said plurality of servers includes said information;
ascertaining an identity of a second server from the remaining servers of said plurality of servers that includes said product information by examining a UDDI repository table located on said one of said plurality of servers, in response to determining said product information is absent from said one of said plurality of servers;
examining a UDDI repository table of said second server to identify an additional server from the plurality of servers, excluding said first and second servers, that includes said product information; and
sending a message to said client terminal with results from said product information.

9. The method as recited in claim 8 wherein transmitting further includes transmitting said search query with said criteria that includes a maximum distance from said client terminal that products corresponding to said product information may be purchased.

10. The method as recited in claim 8 wherein sending further includes sending said message containing results indicating that no products match said search criteria.

11. The method as recited in claim 8 further including an providing additional client terminal and a vendor application and a consumer application both residing on said server, with said additional client terminal having access to said vendor application, defining a vendor client terminal and said client terminal having access to said consumer application, communicating between said client terminal and said vendor terminal through said server employing an instant messaging network.

12. The method as recited in claim 8 further including an providing additional client terminal and a vendor information and a consumer application both residing on said server, with said additional client terminal having access to modify said vendor information, defining a vendor client terminal and said client terminal having access to said consumer application, with said vendor information including data concerning available opportunities and said consumer application rendering said employment opportunities in response to products associated with said vendor information.

13. A system to develop localized markets using business transactions conducted over a data network, said system comprising:
a client terminal in data communication with said data network,
a plurality of servers in data communication with said data network, with each of said plurality of servers including a processor and a memory in data communication with said memory, with said memory storing computer readable instructions when operated on by said processor carries out steps of:
creating a data connection between one of said plurality of servers and a client terminal;
transmitting a search query between said one of said plurality of servers and said client requesting product information to be transmitted between said one of said plurality of servers and said client identifying products satisfying a criteria of said search query;
determining whether said one of said plurality of servers includes said information;
ascertaining an identity of a second server from the remaining servers of said plurality of servers that includes said product information by examining a UDDI repository table located on said one of said plurality of servers, in response to determining said product information is absent from said one of said plurality of servers; and
sending a message to said client terminal with results from said product information.

14. The system as recited in claim 13 wherein transmitting further includes transmitting said search query with said criteria that includes a specified geographic region in which products corresponding to said product information may be purchased.

15. The system as recited in claim 13 wherein transmitting further includes transmitting said search query with said criteria that includes a maximum distance from said client terminal that products corresponding to said product information may be purchased.

16. The system as recited in claim 13 wherein sending further includes sending said message containing results indicating that no products match said search criteria.

17. The system as recited in claim 13 wherein sending further includes following ascertaining and before sending examining a UDDI repository table of said second server to identify an additional server from the plurality of servers, excluding said first and second servers, that includes said product information.

18. The system as recited in claim 13 further including an providing additional client terminal and a vendor application and a consumer application both residing on said server, with said additional client terminal having access to said vendor application, defining a vendor client terminal and said client terminal having access to said consumer application, communicating between said client terminal and said vendor terminal through said server employing an instant messaging network.

19. The system as recited in claim 13 further includes an additional client terminal and vendor information and a consumer application both residing on said server, with said additional client terminal having access to modify said vendor information, defining a vendor client terminal and said client terminal having access to said consumer application, with said vendor information including data concerning available opportunities and said consumer application rendering said employment opportunities in response to products associated with said vendor information.
